(19) United States
(12) Patent Application Publication
(10) Pub. No.: US 2025/0379788 A1
(43) Pub. Date: Dec. 11, 2025

(54) INTELLIGENT SYSTEM TO AUTONOMOUSLY CORRELATE BGP CHANGES AND IMPACTS IN A COMPUTER NETWORK

(71) Applicant: Cisco Technology, Inc., San Jose, CA (US)

(72) Inventors: Lakshmi Ramanathan, Stittsville (CA); Rúben Lopes Da Fonte, Mafra (PT); Newton Norat Siqueira, Santa Maria Da Feira (PT); Sebastian Jeuk, München (DE)

(73) Assignee: Cisco Technology, Inc., San Jose, CA (US)

(21) Appl. No.: 18/739,576

(22) Filed: Jun. 11, 2024

(51) Int. Cl. H04L 41/0823; H04L 41/08; H04L 41/16

(52) U.S. Cl. CPC H04L 41/0836; H04L 41/0883; H04L 41/16

(57) ABSTRACT

In one implementation, a device obtains network characteristic data associated with degraded performance in a computer network. The device also obtains configuration change data associated with a Border Gateway Protocol configuration change implemented in the computer network. The device determines a correlation between the network characteristic data and the configuration change data. The device provides, based on the correlation, an indication that the Border Gateway Protocol configuration change is a cause of the degraded performance in the computer network.

### TECHNICAL FIELD

The present disclosure relates generally to monitoring networks, and, more particularly, to systems and methods to autonomously correlate Border Gateway Protocol (BGP) changes and impacts in a computer network.

### BACKGROUND

Many service provider topologies use Border Gateway Protocol (BGP) route reflectors (RRs) to prevent or otherwise reduce the burden of propagating and processing large volumes of prefixes throughout the network. By consolidating and selectively propagating prefixes, RRs can help optimize the efficiency and scalability of routing in networks. Service providers can use many other types of devices to form the infrastructure of the network. The devices the service providers use may be constantly evolving in terms of capacity and coverage, undergoing frequent configuration changes.

Unfortunately, mistakes can occur during BGP configuration changes, resulting in prefix propagation that can affect the overall performance and stability of the network. During prefix propagation events, service providers can have difficulty identifying the configuration changes that caused the failure. These problems not only occur for service provider networks utilizing RRs but can also occur in enterprise networks, data centers, and other complex network environments. Such configuration mistakes can lead to similar consequences such as routing instability, increased congestion, security vulnerabilities, or even loss of access to entire network.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example correlation intelligence platform; and

FIG. 4 illustrates an example simplified procedure for configuration of changes and impacts in accordance with embodiments of the present disclosure.

### DESCRIPTION OF EXAMPLE IMPLEMENTATIONS

### Overview

According to one or more implementations of the disclosure, a device obtains network characteristic data associated with degraded performance in a computer network. The device also obtains configuration change data associated with a Border Gateway Protocol configuration change implemented in the computer network. The device determines a correlation between the network characteristic data and the configuration change data. The device provides, based on the correlation, an indication that the Border Gateway Protocol configuration change is a cause of the degraded performance in the computer network.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

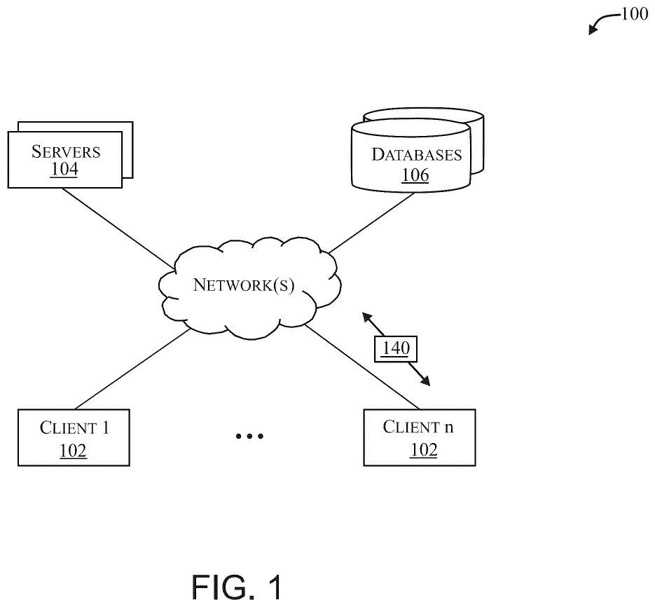

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on Wi-Fi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

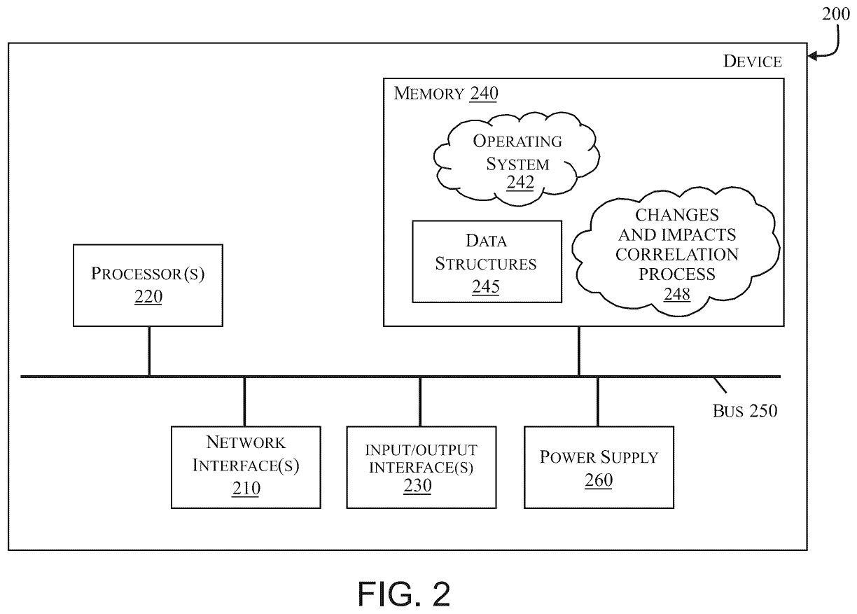

FIG. 2 is a schematic block diagram of an example node/device 200 (e.g., an apparatus) that may be used with one or more embodiments described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device 200. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor 220, functionally organizes the device 200 by, among other things, invoking operations in support of software processes and/or services executing on the device 200. These software processes and/or services may comprise a one or more functional processes (e.g., functional processes 246), and on certain devices, an illustrative changes and impacts correlation process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, changes and impacts correlation process 248 may include computer executable instructions that, when executed by processor(s) 220, cause device 200 to perform the techniques described herein. To do so, in some implementations, changes and impacts correlation process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, changes and impacts correlation process 248 may employ one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that changes and impacts correlation process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, changes and impacts correlation process 248 may also include, or otherwise use, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

As noted above, networks that provide a connection to resources, such as resources available via an internet connection, include essential services for various applications. Many applications require a consistent connection, and even minutes of an outage may not be acceptable for security, safety, and other critical reasons. Network service providers therefore attempt to avoid outages to provide uninterrupted connectivity to accommodate the requirements of the various applications customers utilize the network for.

Many service provider topologies use Border Gateway Protocol (BGP) Route Reflectors (RRs) to prevent or otherwise reduce the burden of propagating and processing large volumes of prefixes throughout the network. By consolidating and selectively propagating prefixes, RRs can help optimize the efficiency and scalability of routing in networks. Service providers can use many other types of devices to form the infrastructure of the network. The devices the service providers use may be constantly evolving in terms of capacity and coverage, undergoing frequent configuration changes. Human configuration mistakes can occur during configuration changes, resulting in prefix propagation that can affect the overall performance and stability of the network.

During prefix propagation events, service providers can have difficulty identifying the configuration changes that caused the failure. These problems not only occur for service provider networks utilizing RRs but can also occur in enterprise networks, data centers, and other complex network environments. Human configuration mistakes can lead to similar consequences such as routing instability, increased congestion, security vulnerabilities or, even loss of access to entire network.

An intelligent system and methods are described herein to monitor the performance of a network at different levels ranging from device level to application level to detect anomalies. Any performance issues detected can be timestamped and details associated with the issue will be gathered. In addition to monitoring network performance, configuration changes will be monitored and commit details will be gathered. Then, service degradation and/or other impacts can be correlated to configuration changes. A configuration change can therefore be identified when the correlation change causes a particular impact, and information can be generated about the impacts the correlation change caused. A user can be alerted about the correlation change and the associated impact for the user to determine how to manage the impact or the configuration change may be automatically rolled back to reverse the impact. As complexity increases, leveraging this task to an intelligent system or engine can be beneficial. Previous correlation data between configuration changes and network impacts can be used to train one or more machine learning/artificial intelligence models to prevent performance outages proactively.

—Correlation of BGP Changes and Impacts in a Computer Network—The techniques herein provide for collecting data associated with various performance characteristics of a network and with configuration changes that are deployed. For example, protocols such as BGP can be modified with a configuration change, and the BGP configuration change can cause impacts on the network. The deployment of configuration changes can be correlated with changes in performance characteristics to identify the configuration change associated with a particular impact to the network. Once a configuration change responsible for an impact is identified, a user can be alerted to address reverting or otherwise modifying the configuration change to undo or otherwise mitigate the impact. In some implementations, a configuration change responsible for an impact may be automatically reverted or otherwise modified, and the user can be alerted about the modification to the configuration change to address the impact.

As the size of a network increases, the complexity to correlate configuration changes with network impacts increases. The techniques herein therefore provide for the use of machine learning/artificial intelligence to analyze input data and identify the configuration changes causing negative impacts in the network's performance. A user can be alerted about the identified configuration changes and/or configuration rollback can be performed. Data associated with previously identified configuration changes causing negative impacts and the actions performed to address the impacts can be used to train a machine learning model to prevent similar performance impacts proactively by predicting the impacts a configuration change will cause before implementation.

Illustratively, the techniques described herein may be performed by hardware, software, and/or firmware, such as in accordance with changes and impacts correlation process 248, which may include computer executable instructions executed by the processor 220 (or independent processor of interfaces 210) to perform functions relating to the techniques described herein.

Specifically, according to various implementations, a device obtains network characteristic data associated with degraded performance in a computer network. The device also obtains configuration change data associated with a Border Gateway Protocol configuration change implemented in the computer network. The device determines a correlation between the network characteristic data and the configuration change data. The device provides, based on the correlation, an indication that the Border Gateway Protocol configuration change is a cause of the degraded performance in the computer network.

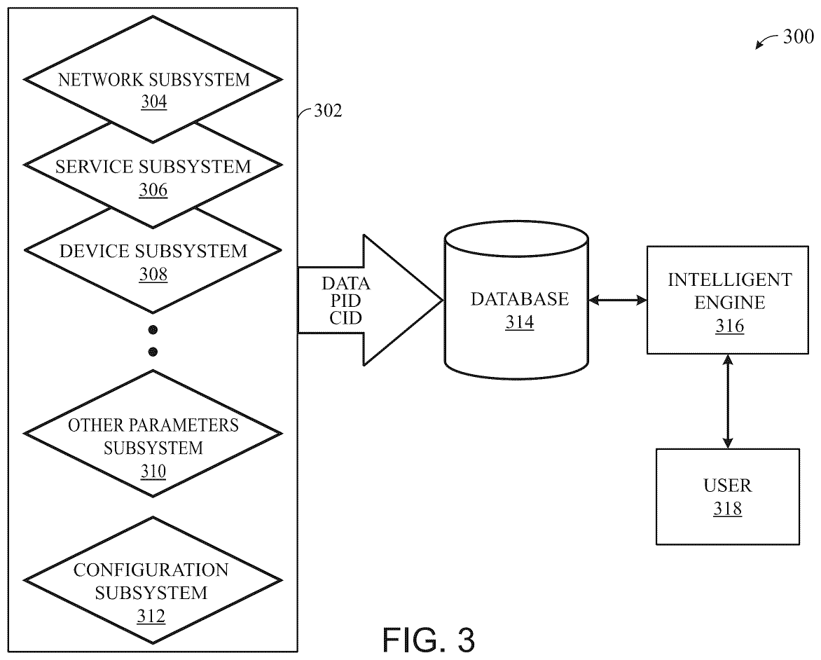

Operationally, FIG. 3 is a block diagram of an example correlation intelligence platform 300 that can implement one or more aspects of the techniques herein. The correlation intelligence platform 300 is a system that monitors and collects performance characteristics data and configuration change data for a network. At the simplest structure, the correlation intelligence platform 300 includes a monitoring system 302 with one or more subsystems for network characteristic monitoring and data collection (e.g., network subsystem 304, service subsystem 306, device subsystem 308, other parameters subsystem 310), one or more subsystems for configuration change monitoring and data collection (e.g., configuration subsystem 312), one or more storages (e.g., database 314, and one or more servers/controllers (e.g., intelligent engine 316). The correlation intelligence platform 300 may also include a user device (e.g., user 318). One or more components of the correlation intelligence platform 300 may be an example device 200 or part of the device 200 as illustrated by FIG. 2.

Various performance metrics can be analyzed to maintain stable and efficient networks, allowing users to seamlessly communicate and access the network. A combination of available performance characteristics of a network can be used to identify network impacts and correlate the impacts with configuration changes. The performance characteristics described below are examples of performance characteristics that can be used to identify network impacts and correlate the impacts with configuration changes.

Other combinations of performance characteristics can used in other implementations, such as a combination of metrics tailored to a specific network configuration, types of devices, and/or according to other characteristics and requirements of the respective network.

Subsystems of the monitoring system 302 monitor and collect performance characteristics of a network, service performance characteristics, device performance characteristics, configuration change data, and/or the like. The subsystems of the monitoring system 302 can send the data to the database 314 for storage, analysis, and/or the like. Note that while FIG. 3 shows four subsystems for network characteristic monitoring (e.g., network subsystem 304, service subsystem 306, device subsystem 308, other parameters subsystem 310), one subsystem for configuration change monitoring (e.g., configuration subsystem 312), one storage (e.g., database 314), one server/controller (e.g., intelligent engine 316), and one user device (e.g., user 318), the total number of subsystems, storages, servers/controllers, and/or users can vary based on a number of factors including the number of networks and/or devices monitored, how distributed the network is, the level of monitoring desired, the type of monitoring desired, the level of network impact mitigation desired, and so on.

The network subsystem 304 can monitor and collect data for the network infrastructure. For example, the network subsystem 304 can monitor parameters such as latency, available bandwidth, utilization, jitter, packet loss, and/or the like. The network subsystem 304 can therefore provide insights into the overall efficiency of the network.

The service subsystem 306 can monitor and collect data associated with the overall performance of specific services and/or applications. For example, the service subsystem 306 can monitor response time, availability, scalability, source/destination network measurement, user experience, and/or the like for one or more services and/or applications. Service performance data includes components such as server hardware, software, databases, application code, and so one besides the network itself.

The device subsystem 308 can monitor and collect data for the performance of individual devices of the network, such as routers or switches. For example, the device subsystem 308 can monitor CPU and memory utilization, interface errors, flaps, throughput, reachability, and/or the like for one or more devices of the network. Identifying faulty or incorrectly operating device(s) can be used to prevent performance issues for additional devices, services, and the network itself.

The other parameters subsystem 310 can monitor and collect data for other devices, infrastructure, services, and/or the like the correlation intelligence platform 300 determines or is otherwise configured for. Thus, other sources of data can be monitored for correlating configuration changes with network impacts. There may be more or fewer subsystems and/or other combinations of subsystems in other implementations, for example depending on the performance characteristics the correlation intelligence platform 300 determines to monitor or is otherwise caused to monitor.

In accordance with certain embodiments, both self-learned baselines and configurable thresholds may be used to identify network impacts. A complex network, for example, has a large number of performance characteristics, and each characteristic can be important in one or more contexts when identify the impact configuration changes have on the network. In such environments, it can be difficult to determine the values or ranges that are normal for a particular metric, set meaningful thresholds on which to base a configuration change causing an impact, and determine what is a normal characteristic or a degraded characteristic when the network or associated infrastructure undergoes a configuration change. For these reasons, the disclosed correlation intelligence platform 300 can perform configuration change impact detection based on dynamic baselines or thresholds, such as through various machine learning techniques, as may be appreciated by those skilled in the art. For example, the illustrative correlation intelligence platform 300 herein may automatically calculate dynamic baselines for the monitored characteristics, defining what is normal for each characteristic based on actual usage. The correlation intelligence platform 300 may then use these baselines to identify subsequent characteristics whose values fall out of this normal range.

The monitoring system 302, via network subsystem 304, service subsystem 306, device subsystem 308, and/or other parameters subsystem 310 for example, may assign Performance Impact Identifier (PID) to data that the monitoring system 302 identifies as data associated with or otherwise indicating a network impact. For example, the monitoring system 302 identifies data associated with an impact based on the baselines or thresholds described above. When a network impact is determined, a PID can be assigned to the network impact, and the PID can identify data indicating the details of the network performance impact (e.g., impact type, devices affected, how the devices are affected, how the network performance is affected, etc.), a timestamp of when the impact started can be assigned, and/or the like. Example PIDs include a first PID with data indicating “the CPU utilization went to ninety-eight percent on a device with device ID R1 at time T0;” a second PID with data indicating “the latency of the network increased to ninety percent at time T1;” a third PID with data indicating “the Domain Name System (DNS) server stopped responding at time T2;” a fourth PID with data indicating “a device with device ID R2 crashed and is not reachable anymore at time T3;” and so on.

The configuration subsystem 312 can continuously monitor the configuration changes in a network. The configuration subsystem 312 can assign a Commit Identifier (CID) to data associated with configuration changes for each configuration change of a network. The CID can identify data associated with configuration change details (e.g., an identifier of the entity that initiated the change, the device IDs of devices involved in the change, etc.), a timestamp of when the change was made, and/or the like. Example CIDs include a first CID with data indicating “User A added a new Border router at time T0;” a second CID with data indicating “User B changed the Maximum Transmission Unit (MTU) on device R1 at time T1;” a third CID with data indicating “User C changed the BGP configuration changes on devices R2, R3, R4 at time T2;” a fourth CID with data indicating “User A has made Multiprotocol Label Switching (MPLS) configuration changes at device R4 at time T3;” and so on.

The intelligent engine 316 is the central processing and administration server for the correlation intelligence platform 300. The intelligent engine 316 can receive data from the database 314, the monitoring system 302, and/or other sources deployed to monitor and gather data associated with network(s) and the associated devices. Any of the systems used to gather data associated with monitoring the network and the data associated with the configuration changes can be implemented to provide various types of data that can include information, characteristics, telemetry data, business data, network data, etc. The intelligent engine 316 can use the data to correlate configuration changes and network impacts to identify the impacts caused by the configuration changes.

The intelligent engine 316 can use the network data (e.g., including the PIDs and associated information) and configuration change data (e.g., including the CIDs and associated information) to correlate configuration changes with network impacts. For example, the intelligent engine 316 may identify a CID of a configuration change that caused the network impact of a PID. When the intelligent engine 316 correlates a configuration change with a network impact, the intelligent engine 316 may generate a correlation output indicating the correlation of the configuration change and the network impact, the type of configuration change, the type of network impact, the severity of the network impact, the confidence level that the configuration change caused the network impact, and/or the like. Example outputs from the intelligent engine 316 include a first correlation indicating a BGP configuration change with a first CID caused a first PID associated with the impact of CPU utilization of ninety percent at time T; a second correlation indicating a MPLS configuration change with a second CID caused a second PID associated with a device R4 crashing at time T1; and so on. The intelligent engine 316 can alert the user 318 and/or other devices of correlated configuration changes and network impacts. The user 318 may then determine how to address the configuration changes to remedy the network impact, such as by rolling back or otherwise modifying configuration changes that cause a network impact.

In some implementations, the intelligent engine 316 can use a correlation field, such as a two-bit field to categorize configuration changes. For example, the intelligent engine 316 can set the two-bit field to “11” to indicate the configuration change is causing a network impact, to “10” to indicate the configuration change is causing no impact, to “01” to indicate the configuration change is impacted by another configuration, and so on. In other example implementation, the field can be any number of bits to indicate more information as desired. The intelligent engine 316 can send a communication (e.g., Physical Layer Protocol Data Unit (PPDU)) including the correlation field to the user 318 and/or other devices to indicate when a configuration change caused a network impact.

The correlation of configuration changes with network impacts can be complex for large networks with many devices used for infrastructure, enabling many services and applications for many clients. The network data and configuration change data can grow large enough to make it prohibitively demanding for human review, particularly when modifying configuration changes can be time sensitive to prevent network downtime and other undesirable network performance characteristics. Therefore, the intelligent engine 316 can automatically correlate this data and determine which configuration change likely caused a network performance impact.

In certain embodiments, the intelligent engine 316 can rollback a configuration change or otherwise revert the network to operate as it was before the configuration change was implemented. In some examples, the intelligent engine 316 may automatically perform a rollback or modification of the configuration change before the network impact will adversely affect network performance. For example, an identified BGP configuration change may a cause performance impact after two hours, and the intelligent engine 316 may revert the BGP configuration change before the two hours in response to identifying the BGP configuration change will cause an impact, in response to determining the user 318 will not send instructions before the two-hour mark, and so on. In other examples, the intelligent engine 316 modifies a configuration change causing a network impact after the network is affected. In some implementations, the intelligent engine 316 may only automatically modify configuration changes that clearly cause an impact (e.g., correlation above a confidence level threshold), the impact is a critical issue (e.g., impact above a severity level threshold), and/or the like. The intelligent engine 316 may require the user 318 to modify the other configuration changes (e.g., configuration changes with correlation below a confidence level threshold, below a severity level threshold, and/or the like).

The intelligent engine 316 may use the data of previously correlated configuration changes and network impacts to improve future performance, including to proactively estimate when a configuration change may cause an impact before the configuration change is implemented. Once the intelligent engine 316 has been correlating configuration changes and network impacts for a sufficient time, the intelligent engine 316 may have sufficient data to train a machine learning model to proactively identify when a configuration change may cause a network impact. The intelligent engine 316 may train the model using algorithms such as Gradient boosting, Bayesian Networks, Support Vector Machines (SVM), and/or the like. Once the model is trained and available to use, the intelligent engine 316 can predict certain types of configuration changes can cause one or more types of network impacts. The intelligent engine 316 can generate warnings regarding potential network impacts, reject configuration changes that will cause network impacts, and/or the like to avoid network performance issues proactively. For example, the intelligent engine 316 can alert a device that requests to implement a configuration change that one or more network impacts may occur, the reasons the impacts may occur, and so on. The device may then review the data to determine whether implementing the configuration change will cause the potential network impacts.

The intelligent engine 316 may serve a User Interface (UI), such as a browser-based UI, which is the primary interface for the user 318 to monitor, analyze, and troubleshoot the network impacts. The intelligent engine 316 can provide the data, correlation information, options to modify configuration changes, actions taken to modify configuration changes, and/or the like via the UI. In some implementations, the user 318 can directly communicate with intelligent engine 316 to display the UI. The intelligent engine 316 can include a visualization system for displaying the data, correlation information, and dashboards related to the disclosed technology. In some implementations, the visualization system can be implemented in a separate machine (e.g., a server) different from the one hosting the intelligent engine 316. The user 318 can modify configuration changes to address correlated network impacts, review and modify the actions of the intelligent engine 316 (e.g., reviewing a rollback of a configuration change identified to cause a network impact), manually identify configuration changes that cause a network impact, and/or the like.

In general, the data collected relates to the configuration changes of the network or associated infrastructure and the topology and/or overall performance of the network or associated infrastructure, such as, latency, available bandwidth, load, average response time, packet loss, error rate, percentage CPU utilization, percentage of memory used, and so on for example. The UI can be used to view all of the data that the subsystems and/or other sources send to or otherwise make available to the controller (e.g., intelligent engine 316) as topologies, heatmaps, graphs, lists, and so on. Illustratively, data can be accessed programmatically using a Representational State Transfer (REST) API (e.g., that returns either the JavaScript Object Notation (JSON) or the extensible Markup Language (XML) format). Also, the REST API can be used to query and manipulate the overall correlation environment.

Those skilled in the art will appreciate that other configurations of correlation intelligence may be used in accordance with certain aspects of the techniques herein, and that other types of subsystems, instrumentations, tests, controllers, and so on may be used to collect data and/or metrics of the network(s), correlate network impacts with configuration changes, modify configuration change implementation, and/or the like. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

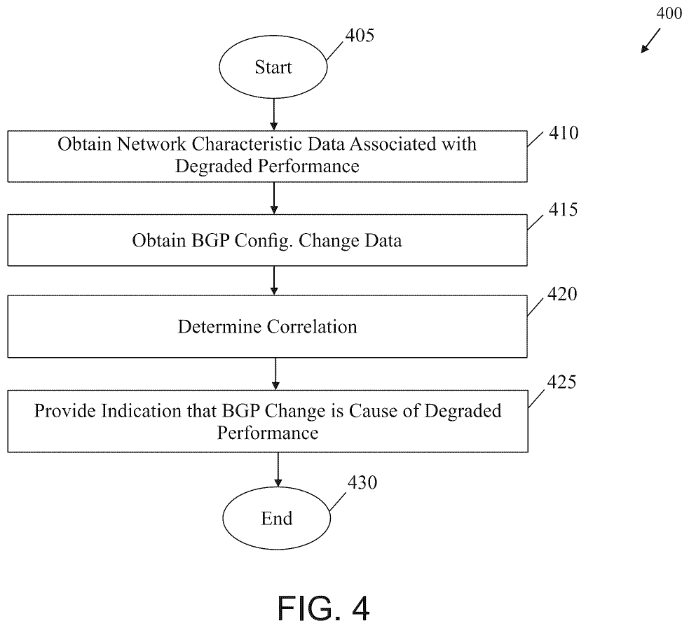

FIG. 4 illustrates an example simplified procedure 400 for correlating configuration changes with network impacts, in accordance with one or more embodiments described herein. For example, a non-generic, a specifically configured device for correlating configuration changes with network impacts (e.g., device 200), may perform procedure 400 (e.g., a method) by executing stored instructions (e.g., changes and impacts correlation process 248). The procedure 400 may start at step 405, and continues to step 410, where, as described in greater detail above, the device (e.g., a controller, processor, etc.) may obtain network characteristic data associated with degraded performance in a computer network. In some instances, the network characteristic data comprises a Performance Impact Identifier (PID) assigned to the degraded performance, wherein the PID identifies data indicating details of the degraded performance and a timestamp of when the degraded performance started. For example, the device may monitor network infrastructure to receive or otherwise collect network data (e.g., latency, available bandwidth, utilization, jitter, packet loss, etc.), services and/or applications to receive or otherwise collect service data (response time, availability, scalability, source/destination network measurement, user experience, etc.), individual devices to receive or otherwise collect device data (CPU and memory utilization, interface errors, flaps, throughput, reachability, etc.), and/or the like. In further implementations, the network characteristic data comprises at least one of: network data from a network subsystem monitoring network infrastructure, service data from service subsystem monitoring services, or device data from a device subsystem monitoring individual devices of a network.

At step 415, as detailed above, the device may obtain configuration change data associated with a BGP configuration change implemented in the computer network. In some instances, the configuration change data comprises a Commit Identifier (CID) assigned to the BGP configuration change, wherein the CID identifies data indicating details of the BGP configuration change and a timestamp of when the BGP configuration change was made.

At step 420, the device may determine a correlation between the network characteristic data and the configuration change data, as described in greater detail above. In some cases, the device may also set a correlation field to indicate the BGP configuration change is causing the degraded performance. In one implementation, the device may also determine a confidence level for the correlation.

At step 425, as detailed above, the device may provide, based on the correlation, an indication that the BGP configuration change is a cause of the degraded performance in the computer network. In various implementations, the device provides the indication to a user interface configured to allow a user to modify the BGP configuration change. In some cases, the device may also modify the BGP configuration change to address the degraded performance. In a further implementation, the device may also train a machine learning model to identify potential degraded performance associated with a potential configuration change using the network characteristic data, the configuration change data, and the correlation. In another implementation, the device may predict potential degraded performance associated with a potential configuration change using the network characteristic data, the configuration change data, and the correlation of the Border Gateway Protocol configuration change with the degraded performance.

Procedure 400 then ends at step 430.

It should be noted that while certain steps within procedure 400 may be optional as described above, the steps shown in FIG. 4 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for correlating configuration changes and network impacts to manage the network impacts. More specifically, by automatically correlating configuration changes and network impacts based on data collected by monitoring network data and configuration change data, configuration changes can be modified to remedy the network impacts and the network impacts a configuration change may cause can be proactively identified before implementing the configuration change without the need for multiple personnel to be involved. This can allow networks to avoid lengthy issues or avoid issues entirely due to configuration changes, thereby enabling more consistent network performance and saving time and money in comparison to current approaches.

While there have been shown and described illustrative embodiments that provide for the correlation of changes and impacts of a network to manage the impacts, including implementing machine learning/artificial intelligence to proactively eliminate impacts, it is to be understood that various other adaptations and modifications may be made within the intent and scope of the embodiments herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device, network characteristic data associated with degraded performance in a computer network;
obtaining, by the device, configuration change data associated with a Border Gateway Protocol configuration change implemented in the computer network;
determining, by the device, a correlation between the network characteristic data and the configuration change data; and
providing, by the device and based on the correlation, an indication that the Border Gateway Protocol configuration change is a cause of the degraded performance in the computer network.

2. The method as in claim 1, wherein the network characteristic data comprises a Performance Impact Identifier (PID) assigned to the degraded performance, wherein the PID identifies data indicating details of the degraded performance and a timestamp of when the degraded performance started.

3. The method as in claim 1, wherein the configuration change data comprises a Commit Identifier (CID) assigned to the Border Gateway Protocol configuration change, wherein the CID identifies data indicating details of the Border Gateway Protocol configuration change and a timestamp of when the Border Gateway Protocol configuration change was made.

4. The method as in claim 1, wherein the device provides the indication to a user interface configured to allow a user to modify the Border Gateway Protocol configuration change.

5. The method as in claim 1, further comprising:
modifying the Border Gateway Protocol configuration change to address the degraded performance.

6. The method as in claim 1, wherein determining the correlation comprises:
setting a correlation field to indicate the Border Gateway Protocol configuration change is causing the degraded performance.

7. The method as in claim 1, wherein the network characteristic data comprises at least one of: network data from a network subsystem monitoring network infrastructure, service data from service subsystem monitoring services, or device data from a device subsystem monitoring individual devices of a network.

8. The method as in claim 1, further comprising:
training a machine learning model to identify potential degraded performance associated with a potential configuration change using the network characteristic data, the configuration change data, and the correlation.

9. The method as in claim 1, further comprising:
predicting potential degraded performance associated with a potential configuration change using the network characteristic data, the configuration change data, and the correlation of the Border Gateway Protocol configuration change with the degraded performance.

10. The method as in claim 1, further comprising:
determining a confidence level for the correlation.

11. An apparatus, comprising:
one or more network interfaces;
a processor coupled to the one or more network interfaces and configured to execute one or more processes; and
a memory configured to store a process that is executable by the processor, the process when executed configured to:
obtain network characteristic data associated with degraded performance in a computer network;
obtain configuration change data associated with a Border Gateway Protocol configuration change implemented in the computer network;
determine a correlation between the network characteristic data and the configuration change data; and
provide, based on the correlation, an indication that the Border Gateway Protocol configuration change is a cause of the degraded performance in the computer network.

12. The apparatus as in claim 11, wherein the network characteristic data comprises a Performance Impact Identifier (PID) assigned to the degraded performance, wherein the PID identifies data indicating details of the degraded performance and a timestamp of when the degraded performance started.

13. The apparatus as in claim 11, wherein the configuration change data comprises a Commit Identifier (CID) assigned to the Border Gateway Protocol configuration change, wherein the CID identifies data indicating details of the Border Gateway Protocol configuration change and a timestamp of when the Border Gateway Protocol configuration change was made.

14. The apparatus as in claim 11, wherein the apparatus provides the indication to a user interface configured to allow a user to modify the Border Gateway Protocol configuration change.

15. The apparatus as in claim 11, wherein the process when executed is further configured to:
modify the Border Gateway Protocol configuration change to address the degraded performance.

16. The apparatus as in claim 11, wherein the apparatus determines the correlation by:
setting a correlation field to indicate the Border Gateway Protocol configuration change is causing the degraded performance.

17. The apparatus as in claim 11, wherein the network characteristic data comprises at least one of: network data from a network subsystem monitoring network infrastructure, service data from service subsystem monitoring services, or device data from a device subsystem monitoring individual devices of a network.

18. The apparatus as in claim 11, wherein the process when executed is further configured to:
train a machine learning model to identify potential degraded performance associated with a potential configuration change using the network characteristic data, the configuration change data, and the correlation.

19. The apparatus as in claim 11, wherein the process when executed is further configured to:
predict potential degraded performance associated with a potential configuration change using the network characteristic data, the configuration change data, and the correlation of the Border Gateway Protocol configuration change with the degraded performance.

20. A tangible, non-transitory, computer-readable medium storing program instructions that cause a device to execute a process comprising:
obtaining, by the device, network characteristic data associated with degraded performance in a computer network;
obtaining, by the device, configuration change data associated with a Border Gateway Protocol configuration change implemented in the computer network;
determining, by the device, a correlation between the network characteristic data and the configuration change data; and
providing, by the device and based on the correlation, an indication that the Border Gateway Protocol configuration change is a cause of the degraded performance in the computer network.
